(19) United States
(12) Patent Application Publication
(10) Pub. No.: US 2010/0014738 A1
(43) Pub. Date: Jan. 21, 2010

(54) METHOD AND SYSTEM FOR BREAST CANCER SCREENING

(75) Inventors: Jason BIRNHOLZ, Oak Brook, IL (US); Christian GALUSCHKY, Munchen (DE); Marcus SCHRECKENBERG, Freising (DE); Bernhard MUMM, Mammendorf (DE)

Correspondence Address: CANTOR COLBURN, LLP, 20 Church Street, 22nd Floor, Hartford, CT, 06103, US

(73) Assignee: TOMTEC IMAGING SYSTEMS GMBH, Unterschleibheim (DE)

(21) Appl. No.: 12/465,341

(22) Filed: May 13, 2009

Related U.S. Application Data
(60) Provisional application No. 61/082,264, filed on Jul. 21, 2008.

(51) Int. Cl. G06K 9/00

(52) U.S. Cl. 382/131; 382/128

(57) ABSTRACT

The invention relates to a system for breast cancer screening and a corresponding method carried out with the system, the method comprising the following steps:
a) providing an image of a predetermined region of a breast of a woman,
b) determining the glandular volume in the scanning image, and
c) calculating the absolute glandular tissue amount of the breast from the glandular volume,
wherein the absolute glandular tissue amount can be used as a risk index which provides an indication about the risk of the woman of having breast cancer.

### TECHNICAL BACKGROUND

The present invention relates to a method and a system for breast cancer screening, in particular for breast cancer screening by ultrasonography or magnetic resonance imaging (MRI). In general, the method and the system of the invention are applicable to any kind of data obtained with various imaging modalities.

In order to further reduce medical treatment and mortality due to breast cancer, it is highly desirable to achieve a better early diagnosis thereof, which may be accomplished inter alia by better screening tools.

Mammography is the standard screening method for breast cancer; however, it faces disadvantages especially in detecting calcifications in young patients. The cost-effective, easy-to-use and non-ionizing modality ultrasound can be used to resolve different tissues within the breast such as fat or glandular tissue. Glandular tissue, or briefly termed gland tissue, is in particular tissue such as the lobes, the lobules, and the milk ducts.

The disadvantages of mammography are that the patients are exposed to ionizing radiation and that the procedure is uncomfortable due to breast compression. Mammography is held to be very sensitive but not specific. Additionally, there are limitations in detecting calcifications in dense breasts.

Nevertheless, mammography is the method of choice for breast cancer screening. So far, breast ultrasound has been established as a valuable diagnostic test, but not as a reliable screening method because it is highly operator dependent and thus cannot be standardized easily.

However, as ultrasound technologies continuously improve, visualization of microcalcifications (i.e. calcifications in the sub-millimeter range), characterization of lesions as malignant or benign as well as ultrasound as an initial screening test becomes realistic. The importance of calcifications and microcalcifications is based on the fact that there is a correlation between microcalcifications and the risk for having breast cancer. However, up to now microcalcifications can be made visible by ultrasound for breast screening only very poorly since the ultrasound resolution has been limited to about 1 millimeter. Hence, current ultrasound scanners for ultrasound screening do not reliably detect microcalcifications in the size range of clinical interest.

Up to now, mammasonography achieves a screening role only for young patients up to an age of 30 years, pregnant patients or mammographic dense, i.e. mastopathic, breasts which account for 40% of the screening population. Mammasonography is the most suitable imaging modality during lactation as well as in cases of an augmented or an inflamed breast.

Electrical impedance imaging measures low-level bioelectric currents, which are altered in cancerous cells. Electrical impedance has achieved FDA approval as an adjunct to mammography, but is unfortunately not useful as a screening tool.

Optical detection methods detect angiogenesis associated with the growth of malignant lesions and are also noninvasive and more comfortable for the patient than mammography, but are not reliable enough as a single screening tool.

Among the disadvantages of current ultrasound techniques are their high false positive rate and that they are not yet ready for screening microcalcifications. Furthermore, ultrasound is not standardized for screening and strongly depends on the skills of the examiner.

### SUMMARY OF THE INVENTION

It is an object of the present invention to provide a method and a system for breast cancer screening which overcome the above-described disadvantages and result in a reliable and improved screening tool.

This object is achieved with a method for breast cancer screening, comprising the following steps:

a) providing an image of a predetermined region of a breast of a woman,

b) determining the glandular volume in the image, and

c) calculating the absolute glandular tissue amount of the breast from the glandular volume,

wherein the absolute glandular tissue amount can be used as a risk index which provides an indication about the risk of the woman of having breast cancer.

According to the invention, a doctor wishing to perform the breast cancer screening method, in order to provide the image, may determine which region of the breast is to be scanned for data acquisition. The scanning of this determined region generates scanning images which may be two-dimensional images or three-dimensional images constructed from a series of two-dimensional images. Alternatively, the doctor may use a respective image taken by another person and/or taken in an earlier stage of the examination for use in the method of the invention.

From the resulting images, the total volume of glandular tissue, i.e. overall volume of the voxels which are to be assigned to gland tissue, is determined. From the glandular tissue volume the absolute glandular tissue amount of the breast of the woman is calculated, which calculation may be performed in an automated, computer-implemented manner.

It is known that fat mainly accounts for breast size and is very variable. Cancer, however, only arises in gland tissue. The volume of gland tissue is much less variable from woman to woman. Correspondingly, there is no strict correlation between the breast cancer risk and the overall breast size.

Gland tissue develops with age, beginning with perimenopause. After menopause, gland tissue persists. The more glandular cells in the gland tissue exist, the higher the risk of cancer may be. Therefore, the assessment of quantitative glandular tissue resulting from a reproducible acquisition thereof yields a risk index for the specific woman, giving an indication about the risk of the woman to have breast cancer.

To summarize, as breast cancer is more prevalent in women with a larger amount of glandular tissue, the approach of the invention is extremely useful for screening and has prognostic value. The impact on patient management is that follow-up exams can be defined according to the risk index.

According to advantageous embodiments of the invention, a step of conducting image pre-processing for improving the image quality for the purpose of image segmentation may be carried out before determination of the glandular volume. As examples, from the scanning image, undesired reflections of the ultrasound echo, which are contained therein and which would disturb the further processing thereof, may be removed. Furthermore, those image portions containing fat may be removed.

It is preferred to use a software scalpel tool for designating a desired region of interest, i.e. for removing image portions which do not belong to the desired region of interest and wherein undesired reflections are contained. Such a scalpel tool performs, as a software program, the same task in the respective image as does a “real” scalpel as a medical tool with respect to a body, namely it cuts away a respective portion of the image.

It is advantageous to use at least one threshold value for being able to distinguish between glandular tissue and fat tissue. Furthermore, even more than one threshold value may be used.

It is preferred, that the scanning of the breast is carried out radially by means of an elongate ultrasonography transducer of which one end is disposed in the vicinity of the nipple and the other end is disposed radially outward thereof. The transducer is then rotated around the nipple in order to be moved in the corresponding measuring or scanning positions.

In case the scanning is carried out continuously during the rotation of the transducer, a high amount of data can be produced, resulting in a high accuracy of the measurement. Alternatively, the scanning may be carried out in selected image planes which are radially oriented and separated from each other by predetermined angles, whereafter the determination of the glandular volume is done by estimating on the basis of the scannings of the selected image planes. The angles between such selected image planes may be, as an example, 30°, 45°, or 60°.

The step of determining the glandular volume is preferably carried out by simply counting the voxels showing gland tissue.

In order to improve the efficiency and accuracy of the determination of the risk index, it is advisable to carry out one or more normalization techniques by which a standardized input image may be achieved. Such normalization techniques comprise the removal of undesired regional reflectivity changes which may be caused by inhomogeneous insonification of the target tissue, e.g. due to inadequate settings of the ultrasound system or due to different accumulated attenuation along the sound wave travel path to the target structures. Furthermore, the normalization techniques may comprise the suppression of structural or temporal noise in scale dimensions which are smaller than a predetermined value, the predetermined value being typically defined by the target structures.

Preferably, the normalization and segmentation techniques comprise the removal of cutaneous and subcutaneous echoes as well as muscles, skin layers, bones and artefacts. This removal my be carried out in a manual or a fully automated manner, as well as in a semi-automatic manner where some points set manually by a user are selected on the screen for supporting the computer in the thresholding procedure.

The quality of the forecast whether a specific woman has a high or a low risk of having breast cancer may be improved by assessing the bone density (measured by x-ray imaging) of the woman and taking into account the result thereof. The reason therefore is that bone density is an indirect indicator of long-time averaged estrogen level. The higher this long-time estrogen level is the higher is the cancer risk.

The forecast quality may be further improved by ascertaining the current BRCA (breast cancer) genes and/or the changes of those BRCA genes of the woman and taking into account the results thereof.

A further improvement of the forecast quality is possible by conducting skin microscopy with the woman and taking the result thereof into consideration, since occurrence of abnormal skin portions may be an indication of the presence of breast cancer.

Considering the ratio of glandular volume to fat volume may under certain circumstances be used as an additional risk index or an additional component for assessing the risk index which provides an indication about the risk of a specific woman of having breast cancer. Therefore, one embodiment of the invention may comprise the steps of determining the fat volume and calculating the ratio of glandular volume to fat volume in order to generate an additional component of the risk index.

Furthermore, the object of the invention may be achieved with a method for breast ultrasonography cancer screening, comprising the following steps:

a) providing an image of a predetermined region of a breast of a woman,

b) removing image portions on which undesired reflections are contained from the image in order to form a first modified image,

c) removing image portions on which fat is contained from the first modified image in order to form a second modified image,

d) determining the glandular volume in the second modified image, and

e) calculating the absolute glandular tissue amount of the breast from the glandular volume,

wherein the absolute glandular tissue amount can be used as a risk index which provides an indication about the risk of the woman of having breast cancer.

In other words, it may be advisable to use the normalization and fat removing steps mentioned above in the order as listed and by generating intermediate images before determination of the glandular volume.

The object of the invention is also achieved with a system for breast cancer screening, comprising:

a scanner for generating a scanning image of a predetermined region of a breast of a woman, and

data processing means which are adapted for carrying out the following steps:

determining the glandular volume in the second modified image, and

calculating the absolute glandular tissue amount of the breast from the glandular volume,

wherein the absolute glandular tissue amount can be used as a risk index which provides an indication about the risk of the woman of having breast cancer.

By use of such a system the absolute glandular tissue amount can be determined and used as a risk index for providing an indication about the risk of a particular woman of having breast cancer or not. Such a system may in particular be used for carrying out screening series, e.g. for carrying out repeated evaluations of the status of the breast which may be especially useful for women for which already a higher risk level has been determined before.

### BRIEF DESCRIPTION OF THE DRAWINGS

FIG. 1 shows a flow diagram for explaining the main steps of the method of the invention,

FIG. 2 shows a system for breast ultrasonography cancer screening according to the invention when applied to a woman's breast,

FIG. 3a and 3b show images before and after removing of undesired image portions, respectively, and

FIG. 4 shows a three-dimensional representation of the glandular tissue.

### DETAILED DESCRIPTION OF THE PREFERRED EMBODIMENTS

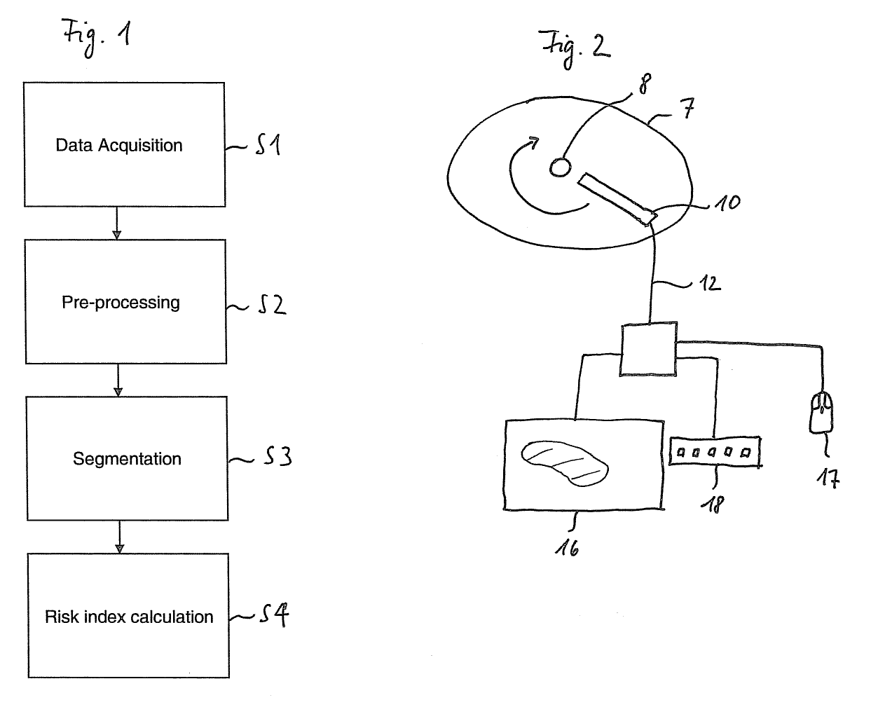

According to FIG. 1, in step S1 of a first, preferred embodiment of the method according to the invention, data acquisition is performed. The patient, i.e. the woman to be scanned, is placed e.g. in a supine, prone or sedentary position for an optimal scanning of the breast, in particular of the gland tissue, such as the lobes, the lobules, and the milk ducts. As depicted in FIG. 2, an ultrasonic transducer 10 which has an elongate shape is placed on the breast 7 of the woman such that one end of the transducer 10 is disposed close to the nipple 8 of the breast 7 and the other end thereof is disposed distant therefrom, the transducer 10 being oriented radially on the breast. The transducer 10 is preferably rotated by 360°, and during the whole rotation ultrasound waves are emitted and the echoes from the woman are recorded by the transducer 10. Alternatively, the transducer 10 may be rotated by an angle of less than 360°, e.g. only by 90° for scanning one quadrant. The radial orientation of the transducer 10 and the rotation around the nipple 8 of the breast 7 are preferred, since the milk ducts are oriented radially and thus can be measured in the best manner.

The recorded data are transmitted to a data processing unit 14 via a communication means 12, such as a cable or a WLAN connection. In order to allow visualization of the various data and images, a display device 16 such as a monitor is connected to the data processing unit 14. Input devices such as a mouse 17 and a keyboard 18 are connected to the data processing unit 14 so that the user is able to select between several display modes, to start and end the measurements as well as to control any step of the method and the several parts of the system according to the invention.

Preferably, the scanning is carried out in a mechanically systematic manner with a probe device or 3D volume scanning using matrix array or wobbler transducers in order to achieve measuring results in a manner as standardized as possible. Alternatively, the breast may also be scanned with the freehand method, in which case of course a position sensor (not shown) for the transducer 10 is used in order to obtain the positional correlation of the measuring results. In this way, a scanning image of the breast is generated.

Next, in step S2, well-known pre-processing is carried out in order to improve the quality of the image, which at first has the form of a histogram. The goal of a first pre-processing step is to prepare the data for segmentation by applying algorithms that allow finding an optimal threshold to separate glandular tissue from other tissue automatically, e.g. histogram-based methods that analyse data on a statistical basis such as the Otsu filter or methods where the histogram is replaced by a Gaussian mixture distribution. Furthermore, algorithms such as unsharp masking or trend correction can be applied to achieve homogeneous data illumination.

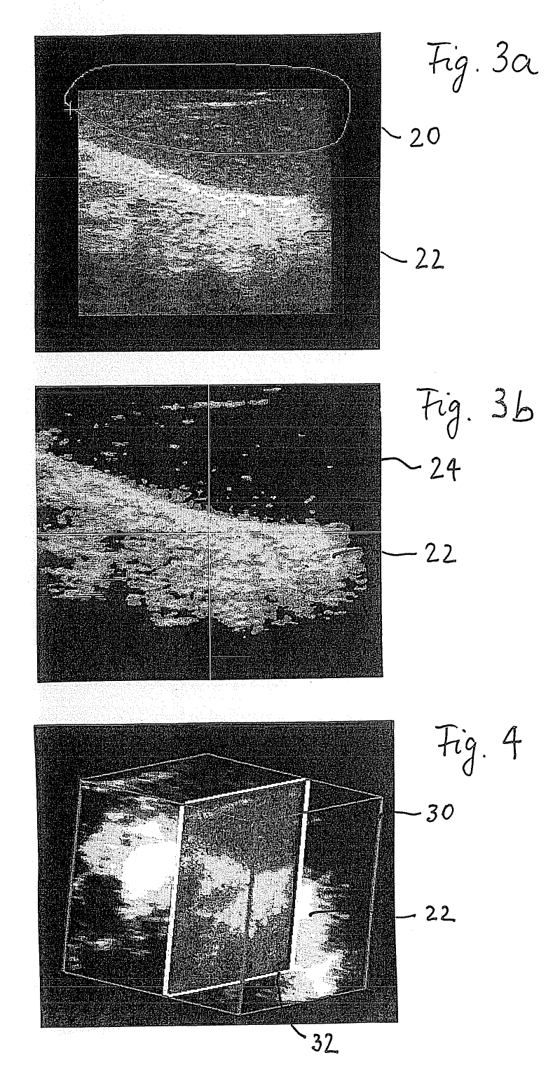

Next, in step S3, by using the mouse 17 or for example a joy stick (not shown), a computer-implemented scalpel tool is used to designate regions in the scanning image which should be removed from the image because they contain reflections which are not desired and result e.g. from skin layers, muscles such as in particular the pectoralis muscle, or artefacts. An example for such an image portion to be removed is designated in FIG. 3a by a white line 20 shaped approximately like an ellipse. The resulting image after removing the undesired portions is depicted in FIG. 3b. In FIG. 3a and 3b, the glandular tissue is designated with the reference numeral 22. Whereas the glandular tissue 22 appears as a bright area, the dark areas 24 in FIG. 3a and 3b correspond to fat. By setting a respective threshold value, a segmentation for separating fat from glandular tissue may be performed. Instead of or additionally to the use of the scalpel tool for cutting away undesired reflections, a second threshold value may be used for removing such undesired reflections.

What results now is an image only containing glandular tissue such as milk ducts, lobes, and lobules, and containing maybe connective tissue. In FIG. 4, such an image is depicted in a three-dimensional manner as one example of a particular display mode. The glandular tissue appearing as a white or bright area is contained in a cube 30. Furthermore, in this cube 30 an additional layer 32 is shown which serves only for a better visualization and has nothing to do with calculating the risk index itself.

From this image, the overall absolute glandular volume is calculated in step S4 by counting the remaining voxels of reflectivity above threshold, i.e. the voxels appearing as a white or bright area. These voxels of high reflectivity will include gland tissue on the one side and connective tissue on the other side. Fortunately, the voxel component assigned to connective tissue adds a relatively small constant value to the voxel component assigned to glandular tissue and does not interfere with the risk assessment.

For risk assessment, the age of the woman may be taken account of. It is known that breast cancer risk increases linearly with age in an age range from 30 to 70 years. As an example, the risk of a 70-year-old woman is three times the risk of a 40-year-old woman. As a further example, the risk of a woman in the age range from 30 to 34 years of falling ill with breast cancer in the subsequent year is about 1:5,000, whereas risk of a woman in the age range from 75 to 79 years is about 1:300. In this way, starting with the individual measurement and risk calculation data—however, without considering the age—of a particular woman, the consideration of the age of that woman allows to calculate a still more realistic risk of having breast cancer.

From this absolute glandular tissue amount, a risk index may be derived which provides an indication whether or not the woman under consideration is likely to have breast cancer.

As a matter of fact, the determination of the overall glandular volume would be possible also without the segmentation of the image carried out beforehand. However, segmentation allows the use of algorithms well known in the state of the art for classifying only the different classes of tissue, namely glandular tissue and non-glandular tissue. It should be clear that during the steps S2 of pre-processing and S3 of segmentation various normalization techniques may be applied in order to achieve image data which are standardized and therefore highly comparable. Such normalization techniques include the suppression of noise, i.e. resulting from various structures under examination. Usually, the sizes of the target structures define the threshold for the suppression of such noise. Furthermore, regional reflectivity changes may be removed which are caused by non-homogeneous application of the ultrasound onto the target issue. Such defects may be caused by inadequate settings of the ultrasound system or by variations in the attenuation of the ultrasound along the travel path of the sound waves from and to the target structures. The normalization may be carried out in a completely automated or in a completely manual manner. It is also possible to use a human-assisted, i.e. semi-automated normalization where a person indicates one or several points on the image in order to help the computer program carrying out the normalization to perform its task.

Given the fact that a long-time averaged estrogen level has an influence on formation of cancer, it may be advisable to assess bone density of a woman scanned by ultrasound, since the bone density is an indirect indicator of such long-time averaged estrogen level. A further possibility of improving the significance of the calculated risk index is to determine the current BRCA (breast cancer) genes of the woman under consideration, since the level of these genes may give a further indication for the risk of the presence of cancer. Also the changes of the BRCA genes over a certain period of time or a combination of the present level of the BRCA genes and the changes thereof may enhance the significance of the calculated risk index.

Also the conduction of skin microscopy may result in a certain conclusion regarding the presence of cancer in the woman under consideration in general, since the risk of having breast cancer is elevated in case skin cancer is already present in the same women. As can be seen, performing the method of the present invention may greatly improve the forecast quality regarding breast cancer. By assessing the quantitative glandular tissue in a reproducible way, monitoring over time in so-called follow-up procedures may be implemented.

A further, second embodiment in carrying out the measurement is to move the transducer 10—one end thereof always kept directed to the nipple 8 and the other end thereof being directed radially outwardly—in a discontinuous manner in one or several distinct angular positions and to carry out the measurement only in these positions. That is, the acquisition of data is performed only in selected planes which are separated by certain angles from each other. These angles may be 20°, 30°, 45° or even 60°, as examples. Based on these measurements in the specified angular positions, the volume of glandular tissue is estimated for one quadrant, as opposed to the more exact calculation carried out in the continuous measurement of the first embodiment. Afterwards, the estimation of the one quadrant may be used for producing an estimation of all four quadrants, i.e. the whole breast. This embodiment is also particularly useful in case a doctor has a specific interest in a particular quadrant of the breast—for example as a result of screening measurements carried out earlier. Such a discontinuous measurement and—as the case may be—focused on only one or two quadrants—can be carried out much quicker and without requiring as much computational power for calculating the glandular amount of interest.

Further to the calculation of the overall glandular volume, also an integration over the entire class of fat tissue may be carried out to calculate the total fat volume. Having done this, also the ratio of glandular volume to fat volume may be calculated and used as a further component for ascertaining the risk index.

Furthermore, the whole volume of the breast may be determined. In this manner, various ratios of the volumes mentioned before may be calculated and stored, preferably for each measurement in the screening series. These values may be useful in future as reference values, and/or for obtaining a normalization over a large quantity of patients.

Instead of counting pixels or voxels with intensity above a threshold as described in the previous embodiments, a nearest neighbor analysis of signal amplitude, e.g. a 9×9 or 9×9×9 patches within the region of interest, may be carried out as well.

1. A method for breast cancer screening, comprising the following steps:
a) providing an image of a predetermined region of a breast of a woman,
b) determining the glandular volume in the image, and
c) calculating the absolute glandular tissue amount of the breast from the glandular volume,
wherein the absolute glandular tissue amount can be used as a risk index which provides an indication about the risk of the woman of having breast cancer.

2. The method according to claim 1, further comprising
a step of conducting image pre-processing for improving the image quality for the purpose of image segmentation, this step being carried out between steps a) and b).

3. The method according to claim 2, wherein the image pre-processing step comprises a step d) of removing image portions on which undesired reflections are contained from the scanning image.

4. The method according to claim 2, wherein the image pre-processing step comprises a step e) of removing image portions on which fat is contained from the scanning image.

5. The method according to claim 3, wherein
step d) is carried out using a scalpel tool for designating a desired region of interest.

6. The method according to claim 4, wherein
step e) is carried out using at least one threshold value in tissue segmentation for distinguishing between glandular tissue and fat tissue.

7. The method according to claim 1, wherein
step a) is carried out by a radial scanning with an elongate ultrasonography transducer which is rotated around the nipple of the breast, one end of the transducer being disposed in the vicinity of the nipple.

8. The method according to claim 7, wherein
the scanning is carried out continuously during the rotation of the transducer.

9. The method according to claim 8, wherein
step b) is carried out by voxel counting.

10. The method according to claim 7, wherein
the scanning is carried out in selected image planes being radially oriented and separated from each other by predetermined angles, and
step b) is carried out by estimating the glandular volume on the basis of the scanning of the selected image planes.

11. The method according to claim 4, wherein
at least one normalization technique for yielding a standardized input image is carried out before step e).

12. The method according to claim 11, wherein
one normalization technique comprises removing undesired regional reflectivity changes.

13. The method according to claim 11, wherein
one normalization technique comprises suppressing structural or temporal noise in scale dimensions smaller than a predetermined value.

14. The method according to claim 11, wherein
one normalization technique comprises the removal of cutaneous and subcutaneous echoes as well as muscles, skin layers, bones, and artifacts in one of a manual, a semi-automatic and a fully automated manner.

15. The method according to claim 1, further comprising
a step of assessing the bone density of the woman, the result of which is taken into account for determining the risk index.

16. The method according to claim 1, further comprising
a step of ascertaining at least one of the current BRCA genes and the BRCA gene changes of the woman, the result of which is taken into account for determining the risk index.

17. The method according to claim 1, further comprising
a step of conducting skin microscopy with the woman, the result of which is taken into account for determining the risk index.

18. The method according to claim 1,
further comprising the steps of
f) determining the fat volume in the image, and
g) calculating the ratio of glandular volume to fat volume,
wherein the ratio of glandular volume to fat volume can be used as a risk index which provides an indication about the risk of the woman having breast cancer.

19. The method according to claim 1, wherein ultrasonography is used for generating the image.

20. The method according to claim 1, wherein magnetic resonance imaging is used for generating the image.

21. A method for breast ultrasonography cancer screening, comprising the following steps:
a) providing an image of a predetermined region of a breast of a woman,
b) removing image portions on which undesired reflections are contained from the image in order to form a first modified image,
c) removing image portions on which fat is contained from the first modified image in order to form a second modified image,
d) determining the glandular volume in the second modified image, and
e) calculating the absolute glandular tissue amount of the breast from the glandular volume,
wherein the absolute glandular tissue amount can be used as a risk index which provides an indication about the risk of the woman of having breast cancer.

22. A system for breast cancer screening, comprising:
data processing means which are adapted for carrying out the following steps:
determining the glandular volume in an image of a predetermined region of a breast of a woman, and
calculating the absolute glandular tissue amount of the breast from the glandular volume,
wherein the absolute glandular tissue amount can be used as a risk index which provides an indication about the risk of the woman of having breast cancer.

23. The system according to claim 22, further comprising
a scanner for generating the image of the predetermined region of the breast of the woman.

24. The system according to claim 23, wherein
the scanner is an ultrasonography scanner.

25. The system according to claim 23, wherein
the scanner is a magnetic resonance imaging scanner.

26. The system according to claim 23, wherein
the data processing means are adapted for carrying out also the step of removing image portions on which undesired reflections are contained from the scanning image.

27. The system according to claim 23, wherein
the data processing means are adapted for carrying out also the step of removing image portions on which fat is contained from the scanning image
